(19) United States
(12) Patent Application Publication
(10) Pub. No.: US 2021/0207929 A1
(43) Pub. Date: Jul. 8, 2021

(54) CARRIER UNIT, ARRANGEMENT COMPRISING A PLURALITY OF CARRIER UNITS AND METHOD OF CONTROLLING THE ARRANGEMENT

(71) Applicant: Dynavisual AG, Zug (CH)

(72) Inventors: René SCHWARZ, Watt (CH); Robert Luka MÜLLER, Meilen (CH)

(21) Appl. No.: 16/770,826

(22) PCT Filed: Jan. 14, 2019
(86) PCT No.: PCT/EP2019/050811

§ 371 Date: Jun. 8, 2020

(51) Int. Cl. F41H 3/02; H04L 29/08; G06Q 20/36

(52) U.S. Cl. CPC F41H 3/02; G06Q 2220/00; G06Q 20/3678; H04L 67/12

(57) ABSTRACT

Carrier unit (1) comprising a textile carrier which at least partially comprises a display unit (2), an interface unit (5) which can be connected to a network (6), and a power supply unit (3) for supplying the display unit (2) and the interface unit (5) with electrical power, wherein the interface unit (5) is operatively connected to the display unit (2) for controlling said unit. Furthermore, an arrangement with a plurality of carrier units and a method for controlling the arrangement are specified.

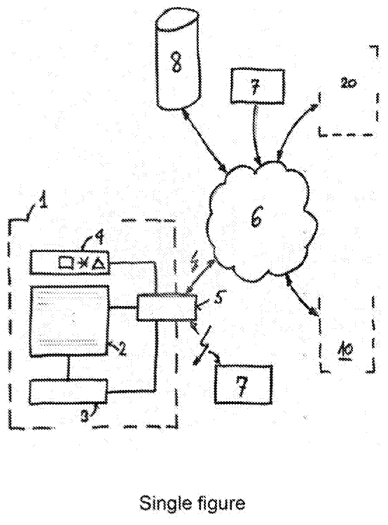

The present invention relates to a carrier unit according to claim 1, an arrangement comprising a plurality of such carrier units, and a method for controlling the arrangement comprising the plurality of such carrier units.

Adaptive camouflage systems, which continuously adapt to the environmental situation in terms of brightness, contrast and color, are offered primarily for military applications. For example, WO 2009/138785 A1 describes panels which are mounted on the outside of submarines. Light-sensitive sensors are also mounted on the outside of the submarines, which measure light conditions—i.e. brightness and color—in the area of the submarine surface. Based on the measured parameters, the panels are controlled in such a way that the contours of the submarine disappear if possible and the surface of the submarine is adapted to the environmental situation as much as possible. This makes it massively more difficult to recognize or detect the submarine due to aerial reconnaissance, independent of the current environmental situation.

Another, also military application also relates to the camouflage of objects with the help of panels. Detailed information can be found in the corresponding publication US 2015/0241176 A1.

Finally, reference is made to publication US 2003/0211797 A1, which describes a textile in which electrical conductor paths are woven. Electrical components such as LED (Light Emitting Diodes) can then be connected to the conductor paths or also woven into the textile fabric.

The technologies mentioned above allow for new applications and business models, and in particular an application in the field of advertising has been envisaged here.

It was the object of the present invention to provide an adaptive and interactive carrier unit.

This object was solved with the carrier unit with the features according to claim 1. Advantageous embodiments of the carrier unit, an arrangement with a plurality of such carrier units and a method for controlling the arrangement are specified in further claims.

The invention first relates to a carrier unit comprising:
a textile carrier comprising at least partially a display unit,
an interface unit connectable to a network, and
a power supply unit for supplying the display unit and the interface unit with electrical energy,
   wherein the interface unit for controlling the display unit is operatively connected to the display unit.

One embodiment variant of the carrier unit according to the invention is characterized in that the textile carrier is designed as a garment.

Further embodiment variants of the carrier unit according to the invention are characterized in that a sensor unit is provided which is operatively connected to the interface unit, wherein the sensor unit preferably comprises at least one of the following sensors:
Temperature sensor;
Positioning sensor, in particular according to the GPS (Global Positioning System);
Microphone;
Photosensitive element, in particular a camera;
Humidity sensor.

Even further embodiment variants of the carrier unit according to the invention are characterized in that the interface unit can be connected to the network via a wireless connection and/or via a wired connection.

Further embodiment variants of the carrier unit according to the invention are characterized in that the display unit can be controlled by means of the interface unit based on data received via the network.

Further embodiment variants of the carrier unit in accordance with the invention are characterized in that the display unit can be controlled by means of the interface unit on the basis of data received via the network and on the basis of sensor data determined with the sensor unit.

Further embodiment variants of the carrier unit according to the invention are characterized in that metallic conductor tracks are woven into the textile carrier to form the display unit.

The present invention further relates to an arrangement comprising a plurality of carrier units, wherein the arrangement further comprises
a network that is operatively connected to the interface units of the carrier units,
a server that is operatively connected to the network.

Finally, the present invention relates to a method for controlling an arrangement comprising a plurality of carrier units, wherein the method comprises the following steps:
Provision of data on a server,
Transferring the data of the server via a network to the interface units of the carrier units,
Preparation of the data received in the interface units,
Control of the display units depending on the processed data.

One embodiment variant of the method according to the invention further comprises the following steps:
Read-out of sensor values from sensor units of the carrier units,
Transmitting the sensor values to the server,
Selecting data stored in the server based on the sensor values,
Transmitting the selected data to the or predetermined carrier units.

Further embodiment variants of the method according to the invention also include the following steps:
Read-out of sensor values from sensor units of the carrier units,
Adaptation of the data received in the interface units based on the read-out sensor values.

Further embodiment variants according to the invention also include the following steps:
Recording of time units for displays on the display unit,
Determination of the time units for each carrier unit, and
Allocation of the determined time units for each carrier unit.

It is expressly pointed out that the above embodiment variants, which belong to the same category, can be combined in any way. Only those combinations of embodiment variants are excluded which would lead to contradictions as a result of the combination.

Embodiment examples of the present invention are explained in more detail below using the single FIGURE. It shows schematically both the components of a carrier unit and the components of an arrangement of a plurality of carrier units in an interconnection with a network.

The only FIGURE schematically shows an arrangement according to the invention with a plurality of carrier units 1, 10, 20, which are operatively connected to a network 6. The network can be the Internet or any other standardized or proprietary network, whether wireless or wired.

A server 8 is also operatively connected to network 6. Data can be stored or processed on server 8. Further explanations of the task and significance of server 8 are given below in connection with possible process controls of the arrangement.

In the single FIGURE three carrier units 1, 10 and 20 are shown. In fact, an arrangement may include a plurality of carrier units 1, 10, 20. However, the structure of carrier units 1, 10 and 20 is identical.

The carrier unit 1 shown in the single FIGURE shows its components, namely a display unit 2, a power supply unit 3, a sensor unit 4 and an interface unit 5. The interface unit 5 is the actual interface to network 6 and can—depending on the configuration—establish and operate a wired or wireless connection to network 6. For the connections mentioned above, well-known technologies are used, such as those known under the keywords LAN, WLAN, Bluetooth, etc. Thus, a direct connection of a control unit 7 to the interface unit 5 is conceivable, for example by means of the Bluetooth standard. A PC or a mobile telephone (smartphone) is conceivable as control unit 7.

An alternative embodiment—if a control unit is desired—is a control unit 7′, which can access the interface unit 5—and thus the corresponding carrier unit 1—via the network 6.

The interface unit 5 is operatively connected to the display unit 2 and the sensor unit 4, wherein no sensor unit 4 is provided in a simplified embodiment variant of the present invention. Consequently, carrier unit 1 then consists of display unit 2 and power supply unit 3 as minimum components. Irrespective of the actual embodiment variant of the present invention, the energy supply unit 3 is operatively connected to the interface unit 5, the display unit and—if present—to the sensor unit 4 and, optionally, to further components.

The interface unit 5 controls the display unit 2 and has its own memory that can store several patterns or images to be displayed on the display unit 2. Another embodiment variant of the interface unit 5 is characterized in that information can also be processed in the interface unit 5. The information can come from sensor unit 4 of the same carrier unit 1, 10, 20 or from server 8 or from one of the control units 7 or 7′.

According to a further embodiment variant of the present invention, it is provided to outsource the processing of information according to the above explanations also to mobile platforms, wherein computer units—for example in the form of a PC—or smartphones can be used as mobile platforms, which can communicate wirelessly or by wire with the interface unit 5 according to the above explanations.

Sensor unit 4 can include one or more of the following sensors:
Temperature sensor;
Positioning sensor, in particular according to GPS (Global Positioning System);
Microphone;
Photosensitive element, in particular a camera;
Humidity sensor.

Carrier units 1, 10 and 20 comprise a textile carrier which at least partially comprises a display unit 2. In one embodiment variant of the present invention, a conventional textile carrier, e.g. based on cotton, polyamide or the like, is provided with a preferably flexible LED (light emitting diode) panel.

In a further embodiment variant of the present invention, electronics or wiring are directly applied to the textile carrier, e.g. by selective plating of metallic conductor tracks on polyamide, polyester or cotton or mixtures thereof. However, it is also conceivable that the metallic conductor paths are woven directly into the textile carrier. Sensors of the above-mentioned type as well as an LED panel or LED array can be applied to the metallic conductor paths as electronics. For insulation purposes, the metallic conductor paths can be insulated by applying a textile print.

In an embodiment variant of the present invention, the textile carrier is designed as an article of clothing, in particular as a T-shirt or jacket.

In the following, an embodiment variant of the method according to the invention for controlling the arrangement according to the invention with a plurality of carrier units 1, 10, 20 is explained:

A possible application of the arrangement shown in the FIGURE is, for example, that the textile carriers are, for example, T-shirts, jackets or the like worn by visitors to an event, such as a sporting event. The display unit 2 according to the invention is then used, for example, to display advertisements selected in particular in accordance with external events. In particular, events which have been detected with the sensor unit 4 serve as selection criteria. Thus, for example, an increase in the volume level—measured with a microphone—, the brightness—measured with the photosensitive element—or the location—determined with the location sensor—can represent such events which trigger an influence on the display unit 2 of individual carrier units 1, 10, 20 or of a plurality of carrier units 1, 10, 20 which fulfil the same criteria or events.

As an alternative to the determination of events with the aid of the sensor unit 4 included in the carrier unit 1, 10, 20, the determination of the contents of the display unit 2 of the individual carrier units 1, 10, 20 can also be specified from a central point. For this purpose, the interface unit 5 receives information from the server 8 or the control unit 7′ via the network 6.

A further embodiment variant of the method according to the invention is that the sensor unit 4 of the individual carrier units 1, 10, 20 sends its information to the server 8 or the control unit 7′, where an evaluation of all information received from the various carrier units 1, 10, 20 is carried out. The result of such an evaluation is transmitted back to the corresponding carrier units 1, 10, 20 or interface units 5 for the control of the information displayed on the display units 2. A large amount of information can thus be evaluated from the plurality of carrier units 1, 10, 20 in order to generate the content for display units 2, with the aim of achieving the best possible advertising effect.

In a further embodiment variant of the method according to the invention, it is provided to pay a remuneration to the owners of the carrier units 1, 10, 20. Such a payment can be made depending on the advertising messages shown on the corresponding display unit 2 or their total display time. The remuneration can then be paid by crediting a bank account electronically. The use of a crypto currency (e.g. Bitcoin) using block chain technology with an associated electronic currency account is particularly advantageous.

### LIST OF REFERENCE NUMERALS

1,10,20 Carrier unit
2 Display unit
3 Power supply unit
4 Sensor unit
5 Interface unit
6 Network
7,7′ Control unit
8 Server

1. Arrangement comprising:
a network (6) which is operatively connected to the interface units (5) of the carrier units (1, 10, 20),
a server (8) which is operatively connected to the network (6),
each carrier unit (1) further comprising:
a textile carrier, comprising at least partially a display unit (2), and
a power supply unit (3) for supplying the display unit (2) and the interface unit (5) with electrical energy,
wherein the interface unit (5) for controlling the display unit (2) is operatively connected thereto.

2. Arrangement according to claim 1, characterized in that the textile carrier is formed as a garment.

3. Arrangement according to claim 1, characterized in that the carrier unit (1) comprises a sensor unit (4) which is operatively connected to the interface unit (5), wherein the sensor unit (4) preferably comprises at least one of the following sensors:
Temperature sensor;
Positioning sensor, in particular according to GPS (Global Positioning System);
Microphone;
Photosensitive element, in particular a camera;
Humidity sensor.

4. Arrangement according to claim 1, characterized in that the interface unit (5) can be connected to the network (6) via a wireless connection and/or via a wired connection.

5. Arrangement according to claim 1, characterized in that the display unit (2) can be controlled with the aid of the interface unit (5) on the basis of data received via the network (6).

6. Arrangement according to claim 1, characterized in that the display unit (2) can be controlled with the aid of the interface unit (5) on the basis of data obtained via the network (6) and on the basis of sensor data determined with the sensor unit (4).

7. Arrangement according to claim 1, characterized in that metallic conductor tracks are woven into the textile carrier to form the display unit (2).

8. (canceled)

9. Method for controlling an arrangement according to claim 1 having a plurality of carrier units (1, 10, 20), wherein the method comprises the following steps:
provision of data on a server (8),
transmission of the data of the server (8) via a network (6) to the interface units (5) of the carrier units (1, 10, 20),
preparation of the data received in the interface units (5),
control of the display units (2) depending on the processed data.

10. Method according to claim 9, which further comprises the following steps:
reading of sensor values from sensor units (4) of the carrier units (1, 10, 20),
transmitting the sensor values to the server (8),
selecting data stored in the server (8) based on the sensor values,
transmitting the selected data to the or predetermined carrier units (1, 10, 20).

11. Method according to claim 9, which further comprises the following steps:
reading of sensor values from sensor units (4) of the carrier units (1, 10, 20),
adapting the data received in the interface units (5) on the basis of the sensor values that were read out.

12. Method according to claim 9, further comprising the following steps:
recording of time units for displays on the display unit (2),
determining the time units for each carrier unit (1, 10, 20), and
allocating the determined time units for each carrier unit (1, 10, 20).

13. Method according to claim 12, which further comprises the following step:
transfer of an amount of money in electronic form to an account of a beneficiary, wherein the amount of money is determined as a function of the determined time units of one or more carrier units (1, 10, 20).

14. Method according to claim 13, in which the amount of money in a crypto currency is determined using a block chain technology.
